(19) United States
(12) Patent Application Publication
(10) Pub. No.: US 2026/0109100 A1
(43) Pub. Date: Apr. 23, 2026

(54) BIODEGRADABLE SHEETS

(71) Applicant: TIPA CORP. LTD, Hod HaSharon (IL)

(72) Inventor: Eli Lancry, Gan-Yavne (IL)

(21) Appl. No.: 19/117,047

(22) PCT Filed: Aug. 28, 2023
(86) PCT No.: PCT/IL2023/050909

§ 371 Date: Mar. 30, 2025

Related U.S. Application Data
(60) Provisional application No. 63/378,139, filed on Oct. 3, 2022.

(51) Int. Cl. B29C 48/18; B29C 48/00; B29C 48/25; B29C 48/345; B29K 67/00

(52) U.S. Cl. CPC B29C 48/18; B29C 48/0018; B29C 48/2515; B29C 48/345; B29C 2948/92647; B29C 2948/92657; B29C 2948/92704; B29K 2067/006; B29K 2067/046

(57) ABSTRACT

Provided is a multilayered biodegradable sheet having at least three layers, such as three layers or five layers, wherein a first outer polymer layer comprises polybutylene succinate (PBSA) and polylactic acid (PLA); a second outer polymer layer comprises polycaprolactone (PCL) and PLA; and a core layer comprises polybutylene adipate terephthalate (PBAT).

### CROSS-REFERENCE TO RELATED APPLICATIONS

This patent application claims priority and benefit from U.S. 63/378,139, filed on Oct. 3, 2022, which is hereby incorporated by reference in its entirety.

### FIELD OF THE INVENTION

The present invention, in at least some embodiments, is directed to biodegradable sheets, and in particular to multilayered biodegradable sheets having at least three layers, wherein a first outer polymer layer comprises polybutylene succinate (PBSA) and polylactic acid (PLA); a second outer polymer layer comprises polycaprolactone (PCL) and PLA; and a core layer comprises polybutylene adipate terephthalate (PBAT).

### BACKGROUND OF THE INVENTION

The use of biodegradable materials had increased over the past years due to the environmentally beneficial properties of such materials. Such materials are now commonly used in the manufacture of a wide range of products, including various types of plastic bags and other forms of packaging. In response to the demand for more environmentally friendly packaging materials, a number of new biopolymers have been developed that have been shown to biodegrade when discarded into the environment.

Examples of such polymers include biopolymers based on polylactic acid (PLA), polyhydroxyalkanoates (PHA), which include polyhydroxybutyrate (PHB), polyhydroxyvalerate (PHV) and polyhydroxybutyrate-hydroxyvalerate copolymer (PHBV), and poly (epsilon-caprolactone) (PCL).

Each of the foregoing biopolymers has unique properties, benefits and weaknesses. For example, PHB and PLA tend to be strong but are also quite rigid or even brittle. This makes them poor candidates when flexible sheets are desired, such as for use in making wraps, bags and other packaging materials requiring good bend and folding capability.

On the other hand, biopolymers, such as polybutylene adipate terephthalate (PBAT), are many times more flexible than the biopolymers discussed above and have relatively low melting points, so that they tend to be self-adhering and unstable when newly processed and/or exposed to heat. Further, due to the limited number of biodegradable polymers, it is often difficult, or even impossible, to identify a single polymer or copolymer that meets all, or even most, of the desired performance criteria for a given application. For these and other reasons, biodegradable polymers are not as widely used in the area of food packaging materials, particularly in the field of liquid receptacles, as desired for ecological reasons.

In addition, the biodegradable sheets known today are mostly opaque, having low light transmittance and high haze. Further, the known biodegradable sheets either do not include barrier layers or include amounts and types of barrier layers that cause the sheets to be generally highly permeable to gases, having both a high oxygen transmission rate and a high water vapor transmission rate, and thus they cannot serve as long term food or drink receptacles.

Additionally, the physical strength of known biodegradable sheets, measured by parameters, such as stress at maximum load, strain at break, and Young's Modulus, is lacking and, therefore, is deficient when used as packaging, particularly when it is desirable to package liquids. Background art includes PCT Publication Nos. WO 2011/158240, WO 2013/088443, WO 2013/186778, WO 2015/059709, WO 2016/067285, WO 2016/174665 and WO 2016/207888 to the present applicant.

There remains a need for biodegradable sheets for packaging, which are devoid of at least some of the disadvantages of the prior art.

### SUMMARY OF THE INVENTION

The present inventors have surprisingly found that a multi-layered biodegradable sheet having at least three layers, wherein a first outer polymer layer comprises PBSA and PLA; a second outer polymer layer comprises PCL and PLA; and a core layer comprises PBAT has an excellent balance between flexibility and extendibility on one hand, with sufficient rigidity on the other hand, and also has excellent water barrier properties.

The mechanical properties of the biodegradable sheets disclosed herein makes such sheets particularly suitable for packaging of bread and similar baked goods.

The biodegradable sheets as disclosed herein are particularly suitable for melt applications due to the relative rigidity, without loss of barrier properties, and are suitable for metallization. Due to the flexibility of the sheets disclosed herein, the visible lines (commonly referred to as “tram lines”) which are frequently seen in prior art sheets are eliminated.

According to an aspect of some embodiments of the present invention, there is provided a biodegradable sheet comprising
a first outer polymer layer;
a second outer polymer layer; and
a core layer located between said first outer polymer layer and said second outer polymer layer,
wherein said first outer polymer layer comprises PBSA and PLA;
wherein said second outer polymer layer comprises PCL and PLA; and
wherein said polymer core layer comprises PBAT.

According to some embodiments, the first outer polymer layer comprises from about 70 wt % to about 90 wt % PBSA and from about 10 wt % to about 20 wt % PLA, such as about 70 wt % PBSA and about 30 wt % PLA, about 75 wt % PBSA and about 25 wt % PLA, about 80 wt % PBSA and about 20 wt % PLA, about 85 wt % PBSA and about 20 wt % PLA, or about 90 wt % PBSA and about 10 wt % PLA.

According to a preferred embodiment, the first outer polymer layer comprises about 85 wt % PBSA and about 15 wt % PLA.

According to some embodiments, the second outer polymer layer comprises from about 10 wt % to about 50 wt % PCL and from about 50 wt % to about 90 wt % PLA, such as about 10 wt % PCL and about 90 wt % PLA, about 15 wt % PCL and about 85 wt % PLA, about 20 wt % PCL and about 80 wt % PLA, about 25 wt % PCL and about 75 wt % PLA, about 30 wt % PCL and about 70 wt % PLA, about 35 wt % PCL and about 65 wt % PLA, about 40 wt % PCL and about 60 wt % PLA, about 45 wt % PCL and about 55 wt % PLA, or about 50 wt % PCL and about 50 wt % PLA.

According to a preferred embodiment, the second outer polymer layer comprises about 20 wt % PCL and about 80 wt % PLA or about 30 wt % PCL and about 70 wt % PLA.

According to some embodiments, the core layer comprises 100 wt % PBAT as the sole polymer in the core layer.

According to an aspect of some embodiments of the present invention, there is provided a biodegradable sheet comprising
a first outer polymer layer comprising about 85 wt % PBSA and about 15 wt % PLA as the sole polymers in the first outer polymer layer;
a second outer polymer layer comprises about 20 wt % PCL and about 80 wt % PLA as the sole polymers in the second outer polymer layer; and
a core layer located between said first outer polymer layer and said second outer polymer layer comprising 100 wt % PBAT as the sole polymer in the core layer.

According to an aspect of some embodiments of the present invention, there is provided a biodegradable sheet comprising
a first outer polymer layer comprising about 85 wt % PBSA and about 15 wt % PLA as the sole polymers in the first outer polymer layer;
a second outer polymer layer comprises about 30 wt % PCL and about 70 wt % PLA as the sole polymers in the second outer polymer layer; and
a core layer located between said first outer polymer layer and said second outer polymer layer comprising about100 wt % PBAT as the sole polymer in the core layer.

According to some embodiments, the biodegradable sheet as disclosed herein further comprises
a first inner polymer layer located between said first outer polymer layer and said core layer; and
a second inner polymer layer located between said second outer polymer layer and said core layer.

According to some embodiments, the first inner polymer layer comprises about 100 wt % PBAT as the sole polymer in the first inner polymer layer; and said second inner polymer layer comprises PCL and PLA as the sole polymers in the second inner polymer layer.

According to some embodiments, the second inner polymer layer comprises from about 10 wt % to about 50 wt % PCL and from about 50 wt % to about 90 wt % PLA as the sole polymers in the second inner polymer layer, such as about 10 wt % PCL and about 90 wt % PLA, about 15 wt % PCL and about 85 wt % PLA, about 20 wt % PCL and about 80 wt % PLA, about 25 wt % PCL and about 75 wt % PLA, about 30 wt % PCL and about 70 wt % PLA, about 35 wt % PCL and about 65 wt % PLA, about 40 wt % PCL and about 60 wt % PLA, about 45 wt % PCL and about 55 wt % PLA, or about 50 wt % PCL and about 50 wt % PLA.

According to a preferred embodiment, the second inner polymer layer comprises about 20 wt % PCL and about 80 wt % PLA or about 30 wt % PCL and about 70 wt % PLA as the sole polymers in the second inner polymer layer.

According to some embodiments, each of the first outer polymer layer and the second outer polymer layer forms from about 15 to about 25% of the total thickness of the sheet and the core layer forms from about 50 to about 70% of the total thickness of the sheet.

According to some embodiments, the composition of the second inner polymer layer is substantially identical to that of the second outer polymer layer. According to some embodiments, the composition of the second inner polymer layer is different from that of the second outer polymer layer.

According to some embodiments, a thickness of the first outer polymer layer is substantially equal to a thickness of the second outer polymer layer.

According to some embodiments, a thickness of the first outer polymer layer is different from a thickness of the second outer polymer layer.

According to some embodiments of a three-layered sheet, each of the first outer polymer layer and the second outer polymer layer form about 20% of the total thickness of the sheet and the core layer forms about 60% of the total thickness of the sheet.

According to some embodiments of a five-layered sheet, each of the first outer polymer layer and the first inner polymer layer forms from about 10 to about 20% (such as about 10%, about 11%, about 12%, about 13%, about 14%, about 15%, about 16%, about 17%, about 18%, about 19% or about 20%); the core layer forms from about 40 to about 60% (such as about 40%, about 42%, about 44%, about 45%, about 46%, about 48%, about 50%, about 52%, about 54%, about 55%, about 56%, about 58% or about 60%) of the total thickness of the sheet; and the each of the second inner polymer layer and the second outer polymer layer forms from about 5 to about 15% (such as about 5%, about 6%, about 7%, about 8%, about 9%, about 10%, about 11%, about 12%, about 13%, about 14%, or about 15%) of the total thickness of the sheet. According to a preferred embodiment of the five-layered sheet, the first outer polymer layer forms about 15% of the total thickness of the sheet; the first inner polymer layer forms about 15% of the total thickness of the sheet; the core layer forms about 50% of the total thickness of the sheet; the second inner polymer layer forms about 10% of the total thickness of the sheet; and the second outer polymer layer forms about 10% of the total sheet.

According to some embodiments, the biodegradable sheet has a total thickness of from about 15 to about 80 μm.

According to some embodiments, the biodegradable sheet according to any embodiments of the present invention is produced by blown extrusion.

### BRIEF DESCRIPTION OF THE FIGURES

Some embodiments of the invention are described herein with reference to the accompanying figures. The description, together with the figures, makes apparent to a person having ordinary skill in the art how some embodiments of the invention may be practiced. The figures are for the purpose of illustrative discussion and no attempt is made to show structural details of an embodiment in more detail than is necessary for a fundamental understanding of the invention. For the sake of clarity, some objects depicted in the figures are not to scale.

In the Figures:

FIG. 1 is a schematic representation of a three-layered sheet in accordance with the principles of the present invention; and

FIG. 2 is a schematic representation of a five-layered sheet in accordance with the principles of the present invention.

### DETAILED DESCRIPTION OF THE INVENTION

### Definitions

Unless otherwise defined, all technical and scientific terms used herein have the same meaning as commonly understood by one of ordinary skill in the art to which the invention pertains. In case of conflict, the specification, including definitions, takes precedence.

The term “biodegradable” as used herein is to be understood to include a polymer, polymer mixture, or polymer-containing sheet that degrades through the action of living organisms in air, water or any combinations thereof within 1 year. Biodegradable polyester degradation is initially by hydrolysis, to eventually break the polymer into short oligomers, and later by microbial degradation, or microbial digestion. Biodegradable material may break down under a variety of conditions, for example under aerobic or anaerobic conditions, in compost, in soil or in water (such as sea, rivers or other waterways).

Material which may be degraded in compost is referred to as compostable. Hence, as used herein, the term “compostable” refers to a polymer, polymer mixture, or polymer-containing sheet which is degraded by biological processes under aerobic conditions to yield carbon dioxide, water, inorganic compounds and biomass and leaves no visible, distinguishable or toxic residues. Composting of such materials may require a commercial composting facility or the material may be home compostable.

As used herein, the term “home compostable” refers to a polymer, polymer mixture, or polymer-containing sheet which is compostable in a home composting container, i.e. at significantly lower temperatures and in the absence of set conditions as compared to those provided in a commercial composting facility. Home composting is usually carried out in significantly smaller volumes than those used for commercial composting, and do not include an industrial shredding process.

The term “sheet” as used herein is to be understood as having its customary meanings as used in the thermoplastic and packaging arts and includes the term “film”. Such sheets may have any suitable thickness, may be of a single polymer layer or of multiple polymer layers. Such sheets may be manufactured using any suitable method including blown film extrusion and cast film extrusion.

As used herein, the term “core layer” of a biodegradable sheet having an odd number of layers refers to the innermost layer of the sheet, such that an equal number of layers (an outer layer and at least one inner layer) is positioned on each said of the core layer.

As used herein, the term “outer layer” of a biodegradable sheet refers to a layer having no additional layer on one side thereof, such that in an unwound such sheet, the outer layer is exposed to the environment.

As used herein, the term “contact layer” of a biodegradable sheet refers to a layer which, when the sheet is used to form a wrapping or package, constitutes the inner surface of the wrapping or package, such that the contact layer may contact material or items contained within the wrapping or package.

As used herein, the term “sealing layer” of a biodegradable sheet refers to a layer which, when the sheet is used to form a wrapping or package, is the layer furthest from the contact layer, and is intended to include a sealing layer to which a coating is optionally applied.

According to some embodiments, the first outer polymer layer is the contact layer and the second outer polymer layer is the sealing layer. According to some embodiments, the first outer polymer layer is the sealing layer and the second outer polymer layer is the contact layer.

As used herein, reference to a specified percentage (w/w) of a polymer layer is intended to refer to the percentage of the specified polymer in a polymer mixture from which the polymer layer is formed. The layer may further comprise a minor amount (no greater than about 5% (w/w) of the total composition of the layer) additives such as slip, anti-block, anti-oxidant and the like. It is to be noted that, as used herein, the singular forms “a”, “an” and “the” include plural forms unless the content clearly dictates otherwise. Where aspects or embodiments are described in terms of Markush groups or other grouping of alternatives, those skilled in the art will recognize that the invention is also thereby described in terms of any individual member or subgroup of members of the group.

As used herein, when a numerical value is preceded by the term “about”, the term “about” is intended to indicate +/−10%.

As used herein, the terms “comprising”, “including”, “having” and grammatical variants thereof are to be taken as specifying the stated features, integers, steps or components but do not preclude the addition of one or more additional features, integers, steps, components or groups thereof. These terms encompass the terms “consisting of” and “consisting essentially of”.

In some embodiments, the biodegradable sheet as disclosed herein is used to prepare a biodegradable package, such as a bag or pouch, for example for containing therein an ingestible substance such as a food, drink or medicine, which may be a solid, semi-solid or liquid substance; or for containing therein a non-ingestible substance such as an item of clothing, a toiletry or cosmetic material or the like. For example, in some embodiments, the biodegradable package is prepared by heat sealing of two or more parts of the same sheet or two or more separate sheets.

As known to a person having ordinary skill in the art, some of the polymers discussed herein have one or more names or spelling thereof. For example, poly (caprolactone) and polycaprolactone are synonymous and the terms are used interchangeably. Similarly, polylactic acid and poly(lactic acid) are synonymous.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Many modifications and variations are possible in light of the above teachings. It is, therefore, to be understood that within the scope of the appended claims, the invention can be practiced otherwise than as specifically described.

The specific embodiments listed below exemplify aspects of the teachings herein and are not to be construed as limiting.

Throughout this application, various publications, including United States Patents, are referenced by author and year and patents by number. The disclosures of these publications and patents and patent applications in their entireties are hereby incorporated by reference into this application in order to more fully describe the state of the art to which this invention pertains.

Citation of any document herein is not intended as an admission that such document is pertinent prior art or considered material to the patentability of any claim of the present disclosure. Any statement as to content or a date of any document is based on the information available to applicant at the time of filing and does not constitute an admission as to the correctness of such a statement.

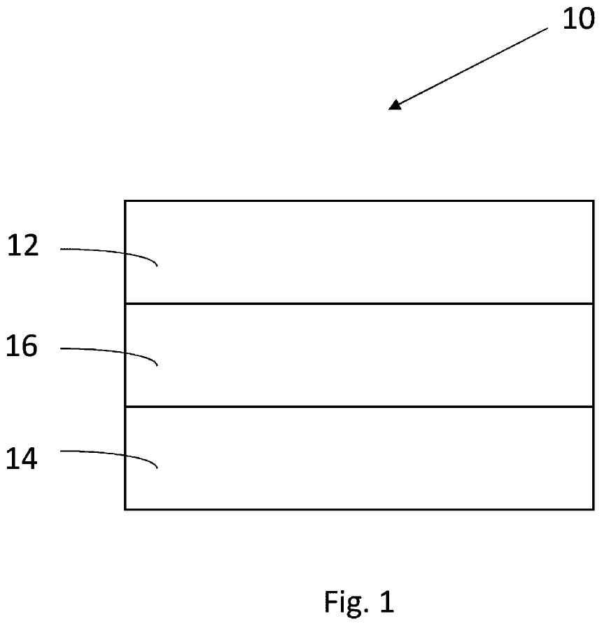

Referring now to FIG. 1, there is shown a schematic representation of three-layered sheet 10, comprising a first outer layer 12, a second outer layer 14 and a core layer 16, wherein core layer 16 is positioned between first outer layer 12 and second outer layer 14.

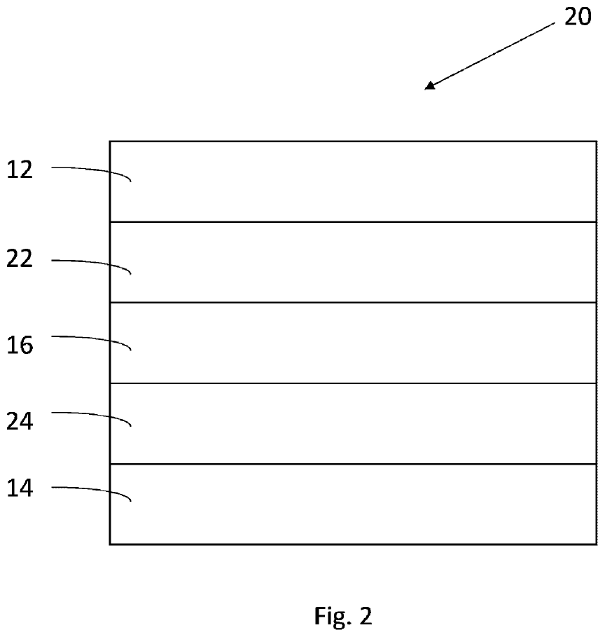

Referring now to FIG. 2, there is shown a schematic representation of five-layered sheet 20, comprising a first outer layer 12, a second outer layer 14, a core layer 16, wherein core layer 16 is positioned between first outer layer 12 and second outer layer 14. Sheet 20 further comprises a first inner layer 22 positioned between first outer layer 12 and core layer 16; and a second outer layer 24 positioned between second outer layer 14 and core layer 16.

### EXAMPLES

In the experimental section below, all percentages are weight percentages.

### Materials and Methods

All the embodiments of polymer sheets according to the teachings herein are made using commercially-available raw materials and devices, using one or more standard methods including: polymer resin drying, resin mixing, cast film extrusion, cast film co-extrusion, blown film extrusion and coextrusion and adhesive lamination.

### Materials

The following polymer resins trials were acquired from commercial sources:

| | |
|---|---|
| PLA | poly(lactic acid) |
| PCL | poly(caprolactone) |
| PBSA | poly(butylene succinate adipate) |
| PBAT | poly(butylene adipate terephthalate) |

The resins may be used as supplied, without further drying. Optionally, before use, resins are further dried, such as by drying overnight in an air flow Shini SCD-160U-120H desiccant dryer heated to about 80° C.

The polymer sheets according to the teachings herein include layers comprising a polymer mixture. Such layers are made by coextrusion of a polymer mixture resin.

To make the required polymer mixture resins, the appropriate amounts of the dried constituent resins are dry-blended and then introduced into the feed zone of the extruders and co-extruded as a film.

### Cast Film Coextrusion of Sheets

Some embodiments of sheets according to the teachings herein are made by coextrusion of three or more layers to make a desired sheet by multilayer cast film co extrusion. Some embodiments of sheets according to the teachings herein are made by lamination of single and multilayer cast film extruded films. Films and sheets are made using a cast film coextruder Dr. Collin (Collin Lab and Pilot Solutions) using standard settings, typically the mixture is fed into the extruder with the temperature zone settings 195° C.; Adaptor at about 200° C.; feedblock at about 200° C.; Die at 210° C. The screw speed is set to provide an extruded layer having the desired thickness in the usual way. For multilayer films, a die having three ports, each fed by a dedicated extruder is used.

### Blown Film Extrusion

Some embodiments of sheets according to the teachings herein are made by coextrusion of one or more layers to make a desired sheet by multilayer blown film co extrusion. These layers are extruded vertically through a circular head. Introducing air through the center of the head creates a “bubble-like” expansion and the properties and thickness of the resulting sheet may be controlled by changing the volume of air and by altering the speed at which the air is introduced.

### Methods

In order to define the physical properties of the biodegradable sheets disclosed herein, the following test methods are used:
a. Tensile strength at break, Young's Modulus and strain at break were measured using the ASTM D882 Standard Test Method for Tensile Properties of Thin Plastic Sheeting in machine direction and transverse direction.
b. Light transmittance and haze were measured using the ASTM D1003 Standard Test Method for Haze and Luminous Transmittance of Transparent Plastics.
c. Water vapor transmission rate (WVTR) was measured using the ASTM F1249 Standard Test Method for Water Vapor Transmission Rate Through Plastic Film and Sheeting Using a Modulated Infrared Sensor at 38° C., 90% RH.
d. Oxygen transmission rate (OTR) was measured using the ASTM D3985 Standard Test Method for Oxygen Gas Transmission Rate Through Plastic Film and Sheeting Using a Coulometric Sensor at 25° C., 0% RH.
e. Sealing strength was measured using the ASTM F2029 Standard Test Method for Seal Strength of Flexible Barrier Materials in machine direction.
f. Sealing temperature range was measured according to ASTM F2029. The films were sealed under high pressure and at a predefined temperature. Specimens for heat sealing were prepared by cutting the test material into strips. Two pieces to be sealed were superimposed one on the other, with the transverse directions parallel and the seal surfaces facing each other. Then, the temperature was elevated until the sealing area reached a melting/failure point. After sealing the strip, the strip was transferred to a load cell for seal-strength analysis and the seal section was peeled by pulling the strip in the machine direction of the web.

### Example 1: Specific Embodiments of 3-Layered Sheets According to the Teachings Disclosed Herein

Exemplary sheets #1-14, representing specific embodiments according to the teachings disclosed herein are prepared, according to Table 1. The total thickness of each sheet is 20 μm.

TABLE 1

| # | First Outer Layer | Core Layer | Second Outer Layer |
|---|---|---|---|
| 1 | 70 wt % PBSA:30 wt % PLA | 100% PBAT | 80 wt % PLA:20 wt % PCL |
| 2 | 75 wt % PBSA:25 wt % PLA | 100% PBAT | 80 wt % PLA:20 wt % PCL |
| 3 | 80 wt % PBSA:20 wt % PLA | 100% PBAT | 80 wt % PLA:20 wt % PCL |
| 4 | 85 wt % PBSA:15 wt % PLA | 100% PBAT | 80 wt % PLA:20 wt % PCL |
| 5 | 90 wt % PBSA:10 wt % PLA | 100% PBAT | 80 wt % PLA:20 wt % PCL |
| 6 | 85 wt % PBSA:15 wt % PLA | 100% PBAT | 90 wt % PLA:10 wt % PCL |
| 7 | 85 wt % PBSA:15 wt % PLA | 100% PBAT | 85 wt % PLA:15 wt % PCL |
| 8 | 85 wt % PBSA:15 wt % PLA | 100% PBAT | 80 wt % PLA:20 wt % PCL |
| 9 | 85 wt % PBSA:15 wt % PLA | 100% PBAT | 75 wt % PLA:25 wt % PCL |
| 10 | 85 wt % PBSA:15 wt % PLA | 100% PBAT | 70 wt % PLA:30 wt % PCL |
| 11 | 85 wt % PBSA:15 wt % PLA | 100% PBAT | 65 wt % PLA:35 wt % PCL |
| 12 | 85 wt % PBSA:15 wt % PLA | 100% PBAT | 60 wt % PLA:40 wt % PCL |
| 13 | 85 wt % PBSA:15 wt % PLA | 100% PBAT | 55 wt % PLA:45 wt % PCL |
| 14 | 85 wt % PBSA:15 wt % PLA | 100% PBAT | 50 wt % PLA:50 wt % PCL |

### Example 2: Specific Embodiments of 5-Layered Sheets According to the Teachings Disclosed Herein

Exemplary sheets #15-42, representing specific embodiments according to the teachings disclosed herein are prepared, according to Table 2. The total thickness of each sheet is 20 μm.

TABLE 2

| | First Outer Layer | First Inner Layer | Core Layer | Second Inner Layer | Second Outer Layer |
|---|---|---|---|---|---|
| 15 | 70 wt % PBSA:30 wt % PLA | 100% PBAT | 100% PBAT | 80 wt % PLA:20 wt % PCL | 80 wt % PLA:20 wt % PCL |
| 16 | 75 wt % PBSA:25 wt % PLA | 100% PBAT | 100% PBAT | 80 wt % PLA:20 wt % PCL | 80 wt % PLA:20 wt % PCL |
| 17 | 80 wt % PBSA:20 wt % PLA | 100% PBAT | 100% PBAT | 80 wt % PLA:20 wt % PCL | 80 wt % PLA:20 wt % PCL |
| 18 | 85 wt % PBSA:15 wt % PLA | 100% PBAT | 100% PBAT | 80 wt % PLA:20 wt % PCL | 80 wt % PLA:20 wt % PCL |
| 19 | 90 wt % PBSA:10 wt % PLA | 100% PBAT | 100% PBAT | 80 wt % PLA:20 wt % PCL | 80 wt % PLA:20 wt % PCL |
| 20 | 85 wt % PBSA:15 wt % PLA | 100% PBAT | 100% PBAT | 90 wt % PLA:10 wt % PCL | 90 wt % PLA:10 wt % PCL |
| 21 | 85 wt % PBSA:15 wt % PLA | 100% PBAT | 100% PBAT | 85 wt % PLA:15 wt % PCL | 85 wt % PLA:15 wt % PCL |
| 22 | 85 wt % PBSA:15 wt % PLA | 100% PBAT | 100% PBAT | 80 wt % PLA:20 wt % PCL | 80 wt % PLA:20 wt % PCL |
| 23 | 85 wt % PBSA:15 wt % PLA | 100% PBAT | 100% PBAT | 75 wt % PLA:25 wt % PCL | 75 wt % PLA:25 wt % PCL |
| 24 | 85 wt % PBSA:15 wt % PLA | 100% PBAT | 100% PBAT | 70 wt % PLA:30 wt % PCL | 70 wt % PLA:30 wt % PCL |
| 25 | 85 wt % PBSA:15 wt % PLA | 100% PBAT | 100% PBAT | 65 wt % PLA:35 wt % PCL | 65 wt % PLA:35 wt % PCL |
| 26 | 85 wt % PBSA:15 wt % PLA | 100% PBAT | 100% PBAT | 60 wt % PLA:40 wt % PCL | 60 wt % PLA:40 wt % PCL |
| 27 | 85 wt % PBSA:15 wt % PLA | 100% PBAT | 100% PBAT | 55 wt % PLA:45 wt % PCL | 55 wt % PLA:45 wt % PCL |
| 28 | 85 wt % PBSA:15 wt % PLA | 100% PBAT | 100% PBAT | 50 wt % PLA:50 wt % PCL | 50 wt % PLA:50 wt % PCL |
| 29 | 70 wt % PBSA:30 wt % PLA | 100% PBAT | 100% PBAT | 50 wt % PLA:50 wt % PCL | 80 wt % PLA:20 wt % PCL |
| 30 | 75 wt % PBSA:25 wt % PLA | 100% PBAT | 100% PBAT | 55 wt % PLA:45 wt % PCL | 80 wt % PLA:20 wt % PCL |
| 31 | 80 wt % PBSA:20 wt % PLA | 100% PBAT | 100% PBAT | 60 wt % PLA:40 wt % PCL | 80 wt % PLA:20 wt % PCL |
| 32 | 85 wt % PBSA:15 wt % PLA | 100% PBAT | 100% PBAT | 65 wt % PLA:35 wt % PCL | 80 wt % PLA:20 wt % PCL |
| 33 | 90 wt % PBSA:10 wt % PLA | 100% PBAT | 100% PBAT | 70 wt % PLA:30 wt % PCL | 80 wt % PLA:20 wt % PCL |
| 34 | 85 wt % PBSA:15 wt % PLA | 100% PBAT | 100% PBAT | 75 wt % PLA:25 wt % PCL | 90 wt % PLA:10 wt % PCL |
| 35 | 85 wt % PBSA:15 wt % PLA | 100% PBAT | 100% PBAT | 90 wt % PLA:10 wt % PCL | 85 wt % PLA:15 wt % PCL |
| 36 | 85 wt % PBSA:15 wt % PLA | 100% PBAT | 100% PBAT | 50 wt % PLA:50 wt % PCL | 80 wt % PLA:20 wt % PCL |
| 37 | 85 wt % PBSA:15 wt % PLA | 100% PBAT | 100% PBAT | 50 wt % PLA:50 wt % PCL | 75 wt % PLA:25 wt % PCL |
| 38 | 85 wt % PBSA:15 wt % PLA | 100% PBAT | 100% PBAT | 55 wt % PLA:45 wt % PCL | 70 wt % PLA:30 wt % PCL |
| 39 | 85 wt % PBSA:15 wt % PLA | 100% PBAT | 100% PBAT | 60 wt % PLA:40 wt % PCL | 65 wt % PLA:35 wt % PCL |
| 40 | 85 wt % PBSA:15 wt % PLA | 100% PBAT | 100% PBAT | 65 wt % PLA:35 wt % PCL | 60 wt % PLA:40 wt % PCL |
| 41 | 85 wt % PBSA:15 wt % PLA | 100% PBAT | 100% PBAT | 70 wt % PLA:30 wt % PCL | 55 wt % PLA:45 wt % PCL |
| 42 | 85 wt % PBSA:15 wt % PLA | 100% PBAT | 100% PBAT | 75 wt % PLA:25 wt % PCL | 50 wt % PLA:50 wt % PCL |

Each layer is extruded from a dedicated extruder, such that five extruders are used for preparing a five-layered sheet.

### Example 3: Properties of an Exemplary 5-Layered Sheet in Accordance with the Principles of the Present Invention

Sheet A, having a composition according to sheet #18 as disclosed in Table 2, having a total thickness of 20 μm, was prepared as an exemplary test sheet.

Sheet B, a comparative 5-layered sheet, having a total thickness of 40 μm, comprising a first inner layer and a first outer layer each comprising about 100wtw % PBSA, and a core layer comprising about 80 wt % PLA and about 20 wt % PCT was prepared.

Each of the two sheets was tested for tensile strength at break, Young's Modulus and strain at break in machine direction (MD) and transverse directions (TD); light transmittance and haze; water vapor transmission rate (WVTR); oxygen transmission rate (OTR); sealing strength; and sealing temperature range.

Results are presented in Table 3 below.

### Results

TABLE 3

| | | Comparative |
|---|---|---|
| Property | Test sheet A | sheet B |
| Yield (g/m²) | 26.27 | 25.22 |
| Tensile strength at break, MD (mPa) | 51 | 38 |
| Tensile strength at break, TD (mPa) | 29 | 18 |
| Youngs modulus, MD (%) | 2,484 | 1,238 |
| Youngs modulus, TD (%) | 2,282 | 987 |
| Strain at break, MD (%) | 4.3 | 73 |
| Strain at break, TD (%) | 11..5 | 300 |
| Light transmittance (%) | 90 | 89.3 |
| Haze | 10.6 | 11.8 |
| WVTR at 38° C., 90% RH (g/m²/24 h) | 36 | 43 |
| OTR at 25° C., 0% RH (cc/m²/24 h) | 490.5 | 1,534 |
| Sealing strength, MD at 100° C. (N/25 mm) | 211 | 15 |
| Sealing temperature range (° C.) | 80-140 | 80-140 |

### DISCUSSION

As shown in Table 3, test sheet A exhibited significantly an increase in tensile strength at break of 34% and 61% in MD and TD, respectively; an increase in Young's modulus of about 100% and 131% in MD and TD, respectively; a reduction in strain at break of about 94% and 96% MD and TD, respectively; a reduction of about 16% in WVTR and of 68% in OTR; and a 14-fold increase in sealing strength with respect to the comparative sheet, while maintaining similar yield, light transmittance, haze and sealing temperature ranges to that of the comparative sheet.

The invention illustratively described herein may suitably be practiced in the absence of any element or elements, limitation or limitations, not specifically disclosed herein. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise indicated.

Although the above examples have illustrated particular ways of carrying out embodiments of the invention, in practice persons skilled in the art will appreciate alternative ways of carrying out embodiments of the invention, which are not shown explicitly herein. It should be understood that the present disclosure is to be considered as an exemplification of the principles of this invention and is not intended to limit the invention to the embodiments illustrated. Those skilled in the art will recognize or be able to ascertain using no more than routine experimentation, equivalents of the specific embodiments of the invention described herein. Such equivalents are intended to be encompassed by the following claims.

1. A biodegradable sheet comprising
a first outer polymer layer;
a second outer polymer layer; and
a core layer located between said first outer polymer layer and said second outer polymer layer,
wherein said first outer polymer layer comprises PBSA and PLA;
wherein said second outer polymer layer comprises PCL and PLA; and
wherein said polymer core layer comprises PBAT.

2. The biodegradable sheet according to claim 1, wherein said first outer polymer layer comprises from about 70 wt % to about 90 wt % PBSA and from about 10 wt % to about 20 wt % PLA.

3. The biodegradable sheet according to claim 2, wherein said first outer polymer layer comprises about 85 wt % PBSA and about 15 wt % PLA.

4. The biodegradable sheet according to claim 1, wherein said second outer polymer layer comprises from about 10 wt % to about 50 wt % PCL and from about 50 wt % to about 90 wt % PLA.

5. The biodegradable sheet according to claim 4, wherein said second outer polymer layer comprises about 20 wt % PCL and about 80 wt % PLA.

6. The biodegradable sheet according to claim 4, wherein said second outer polymer layer comprises about 30 wt % PCL and about 70 wt % PLA.

7. The biodegradable sheet according to claim 1, wherein said core layer consists essentially of 100 wt % PBAT.

8. The biodegradable sheet according to claim 1, further comprising
a first inner polymer layer located between said first outer polymer layer and said core layer; and
a second inner polymer layer located between said second outer polymer layer and said core layer.

9. The biodegradable sheet according to claim 8, wherein
said first inner polymer layer comprises PBAT; and
said second inner polymer layer comprises PCL and PLA.

10. The biodegradable sheet according to claim 9, wherein said first inner polymer layer consists essentially of 100 wt % PBAT.

11. The biodegradable sheet according to claim 9, wherein said second inner polymer layer comprises from about 10 wt % to about 50 wt % PCL and from about 50 wt % to about 90 wt % PLA.

12. The biodegradable sheet according to claim 11, wherein said second inner polymer layer comprises about 20 wt % PCL and about 80 wt % PLA.

13. The biodegradable sheet according to claim 11, wherein said second inner polymer layer comprises about 30 wt % PCL and about 70 wt % PLA.

14. The biodegradable sheet according to claim 1, wherein each of said first outer polymer layer and said second outer polymer layer forms from about 15 to about 25% of the total thickness of the sheet and wherein said core layer forms from about 50 to about 70% of the total thickness of the sheet.

15. The biodegradable sheet according to claim 14, wherein each of said first outer polymer layer and said second outer polymer layer form about 20% of the total thickness of the sheet and wherein said core layer forms about 60% of the total thickness of the sheet.

16. The biodegradable sheet according to claim 1, wherein said first outer polymer layer forms from about 10 to about 20% of the total thickness of the sheet, said first inner polymer layer forms from about 10 to about 20% of the total thickness of the sheet, said core layer forms about 40 to about 60% of the total thickness of the sheet, said second inner polymer layer forms from about 5 to about 15% of the total thickness of the sheet and said second outer polymer layer forms about 5 to about 15% of the total thickness of the sheet.

17. The biodegradable sheet according to claim 16, wherein said first outer polymer layer forms about 15% of the total thickness of the sheet, said first inner polymer layer forms about 15% of the total thickness of the sheet, said core layer forms about 50% of the total thickness of the sheet, said second inner polymer layer forms about 10% of the total thickness of the sheet and said second outer polymer layer forms about 10% of the total sheet.

18. The biodegradable sheet according to claim 1, having a total thickness of from about 15 to about 80 μm.
